(19) United States
(12) Patent Application Publication
(10) Pub. No.: US 2025/0355966 A1
(43) Pub. Date: Nov. 20, 2025

(54) METHODS AND APPARATUSES FOR CONVOLUTION OF INPUT DATA

(71) Applicant: Taiwan Semiconductor Manufacturing Company, Ltd., Hsin-Chu (TW)

(72) Inventors: Win-San Khwa, Taipei City (TW); Yi-Lun Lu, New Taipei City (TW); Jen-Chieh Liu, Hsinchu (TW); Jui-Jen Wu, Hsinchu (TW); Meng-Fan Chang, Taichung City (TW)

(21) Appl. No.: 19/282,139

(22) Filed: Jul. 28, 2025

Related U.S. Application Data
(63) Continuation of application No. 18/402,810, filed on Jan. 3, 2024.
(60) Provisional application No. 63/518,978, filed on Aug. 11, 2023.
(60) Provisional application No. 63/607,169, filed on Dec. 7, 2023.

(51) Int. Cl. G06F 17/16; G06F 5/01; G06F 17/15

(52) U.S. Cl. CPC G06F 17/16; G06F 5/01; G06F 17/15

(57) ABSTRACT

Embodiment described herein provide systems, apparatuses and methods for convoluting a filter (“kernel”) to input data in the form of an input array by reusing computations of repeated data entries in the input array due to convolution movements from one convolution step to the next. In one embodiment, to compute a convolution of an input matrix and a filter matrix, instead of unrolling data entries from the input matrix of each convolution step into an input vector, only non-repeated new data entries at each convolution step may be added to the input vector. An input mapping circuit that implements an input parameter mapping matrix may then iteratively map data entries of the input vector to different weight registers that corresponds to weights in the filter matrix.

### PRIORITY CLAIMS

The instant application is a continuation application of and claimed priority under 35 U.S.C. 120 to U.S. nonprovisional application Ser. No. 18/402,810, filed Jan. 3, 2024, which in turn is a nonprovisional of and claims priority under 35 U.S.C. 119 to U.S. Provisional Application No. 63/518,978, filed Aug. 11, 2023, and U.S. Provisional Application No. 63/607,169, filed Dec. 7, 2023, each of which is hereby expressly incorporated by reference herein in its entirety.

### BACKGROUND

An Artificial Intelligence (AI) accelerator comprises a specialized hardware component and/or device to accelerate the execution of AI and machine learning workloads. An example workload includes an operation of convolution that is often performed in deep learning and convolutional neural networks, e.g., in tasks such as image recognition, natural language processing, computer vision, and/or the like. Convolution involves applying a filter (also referred to as “kernel”) matrix to an input data matrix to extract features. Such computation further entails, for each position of the input matrix and the kernel matrix, corresponding entry values are multiplied and added together. Traditional AI accelerator performs multiplications for each convolution step by unrolling and expanding input parameters from the input matrix into a vector form even when some input parameters may repeat across different convolution steps. Thus, a large amount of input registers are often needed to store the unrolled input vector from the input matrix, which leads to the use of significant circuit area and computational power.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example of a convolution layer in a convolutional neural network (CNN) performing a convolution operation, according to one or more embodiments described herein.

FIGS. 2A-2B illustrate examples of the convolution operation shown in FIG. 1, according to one or more embodiments described herein.

FIGS. 3A-3B show examples of unrolling an input data array without and with data reuses into an input vector for performing a convolution with filter matrix in the example shown in FIGS. 2A-2B, according to one or more embodiments described herein.

FIG. 3C-3D illustrate the example input data reuse rate corresponding to FIG. 3B, according to embodiments described herein.

FIG. 4 shows an example structure of a circuit for computing a convolution operation using the memory-efficient data unrolling scheme shown in FIG. 3B, according to one or more embodiments described herein.

FIG. 5 shows an example structure of the stride-aware input mapping circuit shown in FIG. 4 using a shift-type register to selectively input, according to one or more embodiments described herein.

FIG. 6 shows an example structure of the stride-aware input mapping circuit shown in FIG. 4 using an input multiplexer to selectively input, according to one or more embodiments described herein.

FIG. 7 shows an example circuit structure of the stride matrix shown in FIGS. 5-6, according to one or more embodiments described herein.

FIGS. 8A-8B illustrate example stride matrices for stride-1 convolution, according to one or more embodiments described herein.

FIGS. 9A-9B illustrate example stride matrices for stride-2 convolution, according to one or more embodiments described herein.

FIGS. 10A-10C illustrate example stride matrices for stride-1 and stride-2 combining the stride matrices design shown in FIGS. 8A-9B, according to one or more embodiments described herein.

FIGS. 11A-11B provide an illustrative example showing a hardware implementation of the superposed stride matrix 1006 in FIG. 10B, according to embodiments described herein.

FIGS. 12A-12C illustrate example input multiplexer mapping using input multiplexer in FIG. 6, according to one or more embodiments described herein.

FIG. 13 is an example logic flow chart illustrating a process for performing a convolution of an input array with a filter matrix using circuit structures described in FIGS. 1-12, according to embodiments described herein.

FIG. 14 is a simplified diagram illustrating a computing device implementing the convolution operation using an input mapping circuit described in FIG. 1-13, according to one embodiment described herein.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

The instant application relates to computational circuits, and more specifically to methods and apparatuses for convolution of input data. Embodiment described herein provide systems, apparatuses and methods for convoluting a filter (“kernel”) to input data in the form of an input array by reusing computations of repeated data entries in the input array due to convolution movements from one convolution step to the next. In one embodiment, to compute a convolution of an input matrix and a filter matrix, instead of unrolling data entries from the input matrix of each convolution step into an input vector, only non-repeated new data entries at each convolution step may be added to the input vector. The resulting input vector may then be input to an input register. An input mapping circuit that implements an input parameter mapping matrix may then iteratively map data entries of the input vector to different weight registers that corresponds to weights in the filter matrix. A compute unit may then perform a multiplication of the mapped data entries and corresponding weights, and such multiplication results are added together for a convolution step.

In this way, as data entries from the original input data array are re-used across different convolution steps when convolution movements proceed, fewer out-of-macro memory accesses may be performed, which improves memory bandwidth efficiency. In addition, with fewer data movements between memory and/or input registers, input buffer dynamic energy efficiency may be improved.

In one embodiment, systems that applies the input parameter mapping matrix to perform a convolution between an input data matrix and a filter matrix, such as an AI accelerator executing operations of a convolutional neural network (CNN), a communication and/or speech/video processing system that applies a filter on input data, and/or the like, may improve computational, memory and power efficiency by reducing memory bandwidth requirement and/or buffer dynamic energy requirement. Thus, AI, communication and speech technology and/or other types of technology are improved.

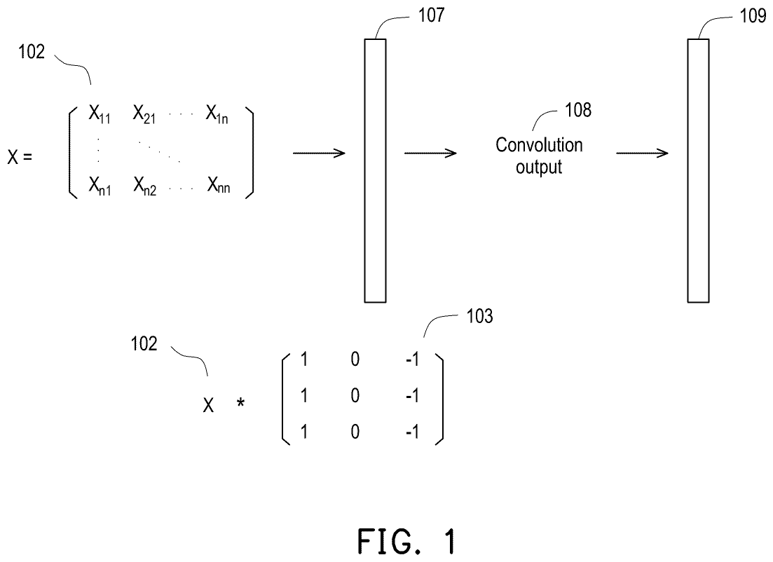

FIG. 1 illustrates an example of a convolution layer in a CNN performing a convolution operation, according to one or more embodiments described herein. In one embodiment, a neural network may comprise a plurality of layers 107, 109, and/or the like. Layer 107 may perform a convolution operation on input data array (matrix) 102 with a kernel and/or filter matrix 103 of weights. The convolution output 108, e.g., the result of convoluting input matrix 102 with kernel matrix 103, may then be passed on to the next layer 109. In one embodiment, the convolution output 108 may take a form of a feature map representing features extracted from input matrix 102.

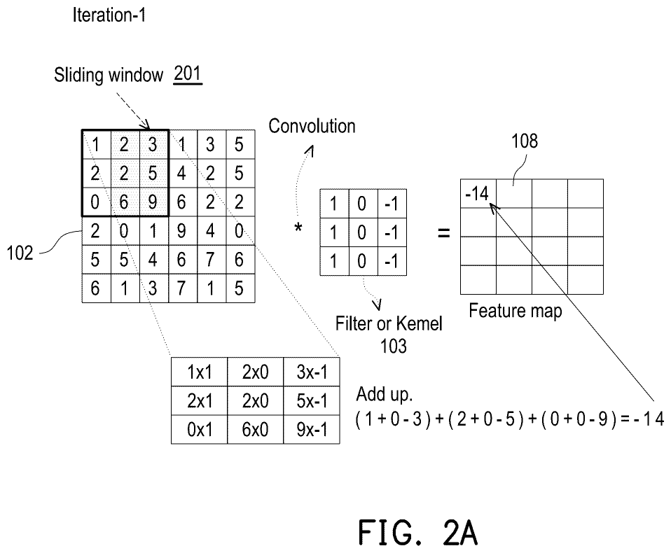

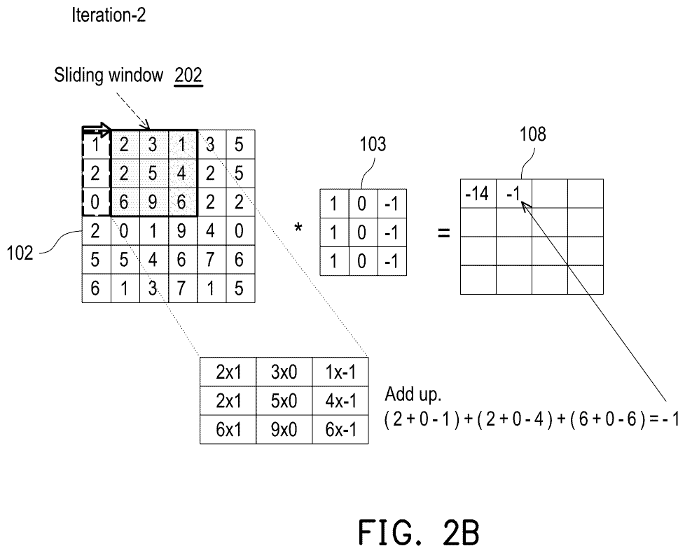

FIGS. 2A-2B illustrate examples of the convolution operation shown in FIG. 1, according to one or more embodiments described herein. In at least one embodiment, a convolution operation may be performed in one or more iterations. For example, as shown in FIG. 2A, at a first iteration of the convolution of input matrix 102 and kernel matrix 103, the portion within the sliding window 201 may perform a dot product with the kernel matrix 103, and the results are aggregated to result in the sum “−14” as the corner entry of feature matrix 108. In one embodiment, as sliding window 201 contains a corner entry of the input matrix 102, the iteration may be referred to as a “corner” mode of the convolution.

In FIG. 2B, at the second iteration of the convolution, the sliding window may move to the position 202 to repeat a similar operation of matrix dot product and summing of the products to result in “−1” as the second entry in the resulting feature matrix 108. As the sliding window 202 of the second iteration does not contain a corner of input matrix 102, this iteration may be referred to as a “non-corner mode of the convolution.”

In one embodiment, the sliding window may continue to move from left to right until each entry of the 4×4 feature matrix 108 is computed using the similar operation of matrix dot product and summing of the products as described above.

In one embodiment, in the respective example shown in FIGS. 2A-2B, from the first iteration in FIG. 2A to the second iteration in FIG. 2B, sliding window moves one column from left to right. Such amount of movement is referred to “stride,” e.g., stride=1 in this example in FIGS. 2A-2B. In some embodiments, stride may be set as 1, 2, 3, . . . , while in CNN, stride may be set as 1 or 2. In one embodiment, a neural network may comprise multiple convolution layers that may adopt different strides.

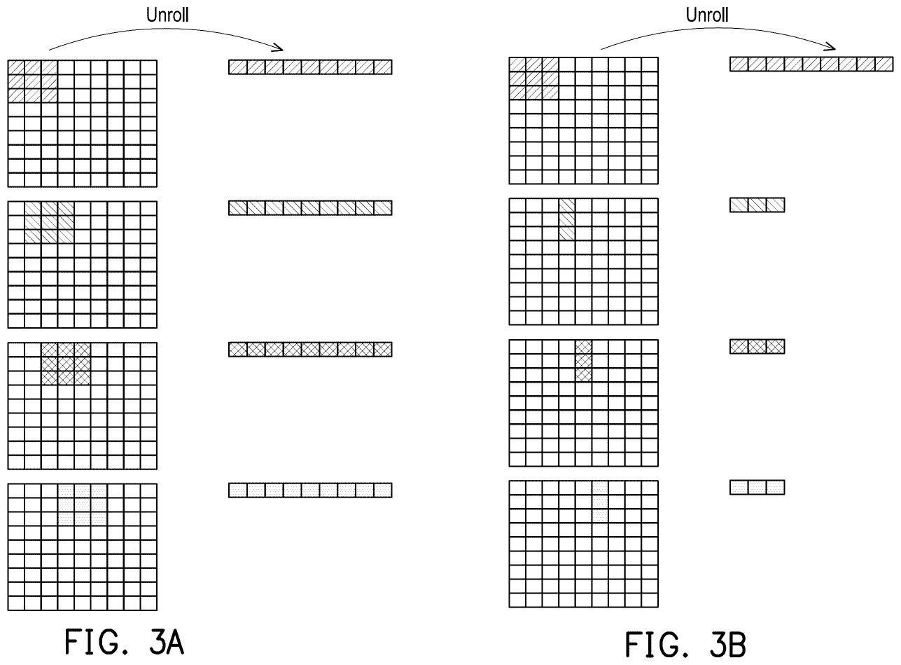

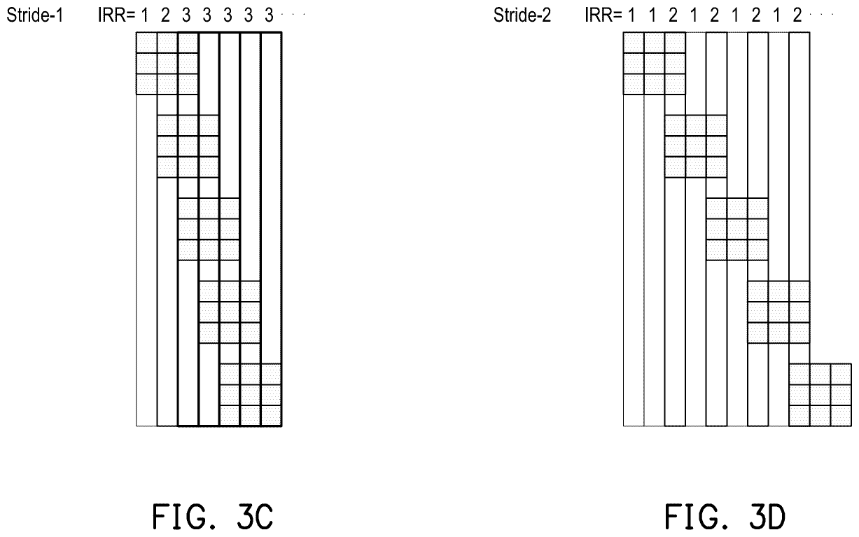

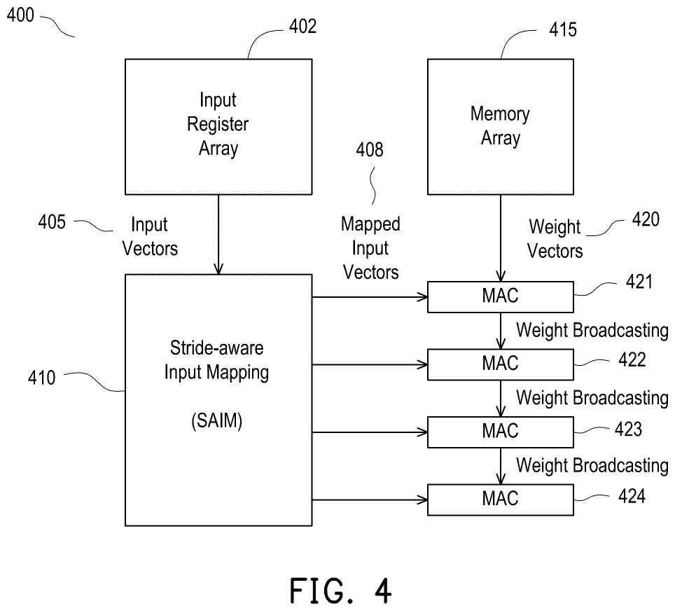

FIGS. 3A-3B show examples of unrolling an input data array 102 without and with data reuses into an input vector for performing a convolution with filter matrix 103 in the example shown in FIGS. 2A-2B, according to one or more embodiments described herein. As shown in FIG. 3A, in one embodiment, traditional convolution network unrolls an input data array without any data re-use, e.g., all input parameters used in performing neighboring 3×3 convolution with filter matrix 103 (shown in FIGS. 2A-2B) are unrolled into an input vector. Thus, assuming four compute units (e.g., multiply-accumulate (MAC) units 421-424 shown in FIG. 4) are used to compute the convolution, a total of 9×4=36 parameters are unrolled into the input vector and thus stored in an input register.

As shown in FIG. 3B, instead of unrolling all input parameters from input data array 102 for performing neighboring 3×3 convolution, only distinct and non-repeated input parameters used in four neighboring 3×3 convolutions are unrolled into the input vector. In this way, the input vector contains a total of 9+3×3=18 input parameters for storing at the input register. Therefore, with data re-use, less input register capacity and/or fewer out-of-macro memory accesses to read data into the input register may be performed, which improves memory efficiency.

FIG. 3C-3D illustrate the example input data reuse rate corresponding to FIG. 3B, according to embodiments described herein. When only non-repeated data entries from input data array is unrolled into the input vector, previously unrolled data entries may be reused in more than one compute. The input re-use rate (IRR) may be defined as the number of compute per memory fetch. As shown in FIG. 3C, for stride-1 convolution, input data re-use rate approaches 3 when the input data array is significantly large then the filter size, and thus a large number of iterations are to be performed. As shown in FIG. 3D, for stride-2 convolution, because input data re-use rate approaches 1.5 when the input data array is significantly larger than filter size.

FIG. 4 shows an example structure of a circuit 400 for computing a convolution operation using the memory-efficient data unrolling scheme shown in FIG. 3B, according to one or more embodiments described herein. In one embodiment, circuit 400 may comprise an input register array 402, a stride-aware input mapping circuit 410, a plurality of compute units (e.g., MAC units) placed in parallel, and a memory array 415, and/or the like.

In one embodiment, input register array 402 may be an out-of-macro memory unit configured to store input data array 102 shown in FIGS. 1-2B. Input vectors 405 which are formed by unrolling only non-repeated data entries for performing neighboring convolutions, e.g., as shown in FIG. 3B. Input vectors 405 may be send to a stride-aware input mapping circuit 410.

In one embodiment, side-aware input mapping circuit 410 may map an input vector 405 to an output vector 408, e.g., each data entry in input vector 405 is selectively mapped to a particular position in the output vector 408 such that the mapped data entry is passed to a particular weight register in one of the MACs 421-424. MAC units 421-424 may load weight vectors 420 (e.g., relating to entries in the filter matrix 103 in FIGS. 2A-2B) from a memory array 415 and broadcast the weight vectors 420 into its weight registers. The corresponding MAC unit may then perform a multiplication of the mapped data entry and a particular weight stored in the particular weight register to compute the convolution operation as shown in FIGS. 2A-2B.

It is to be noted that circuit 400 contains four MAC units 421-424 corresponding to the convolution between a 6×6 input matrix 102 and a 3×3 filter matrix 103 shown in FIGS. 2A-2B for illustrative purpose only. In other examples, circuit 400 may contain other number of MAC units depending on the size of input matrix and/or the filter matrix.

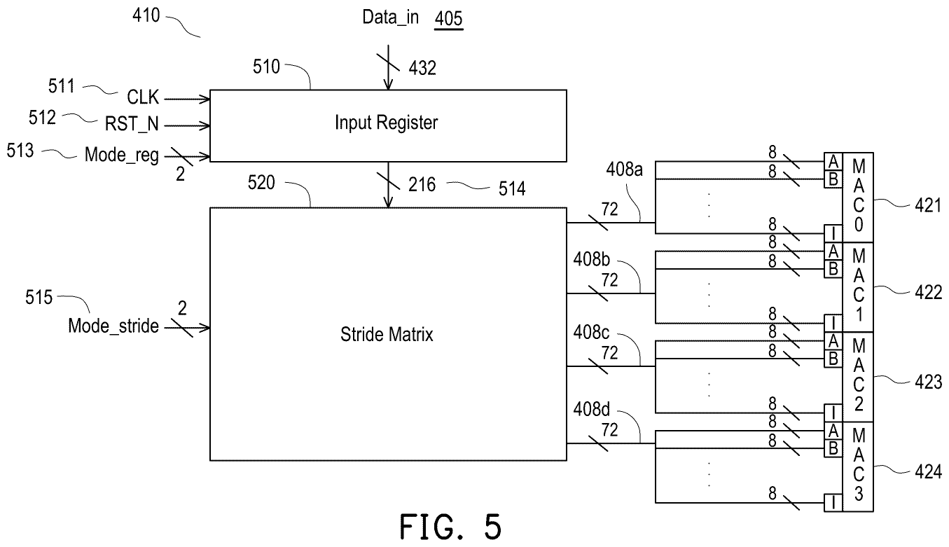

FIG. 5 shows an example structure of the stride-aware input mapping circuit 410 shown in FIG. 4 using a shift-type register to selectively input, according to one or more embodiments described herein. In one embodiment, stride-aware input mapping circuit 410 may comprise an input register 510, and a stride matrix structure 520 which is communicatively connected to a plurality of MAC units 421-424 that are placed in parallel.

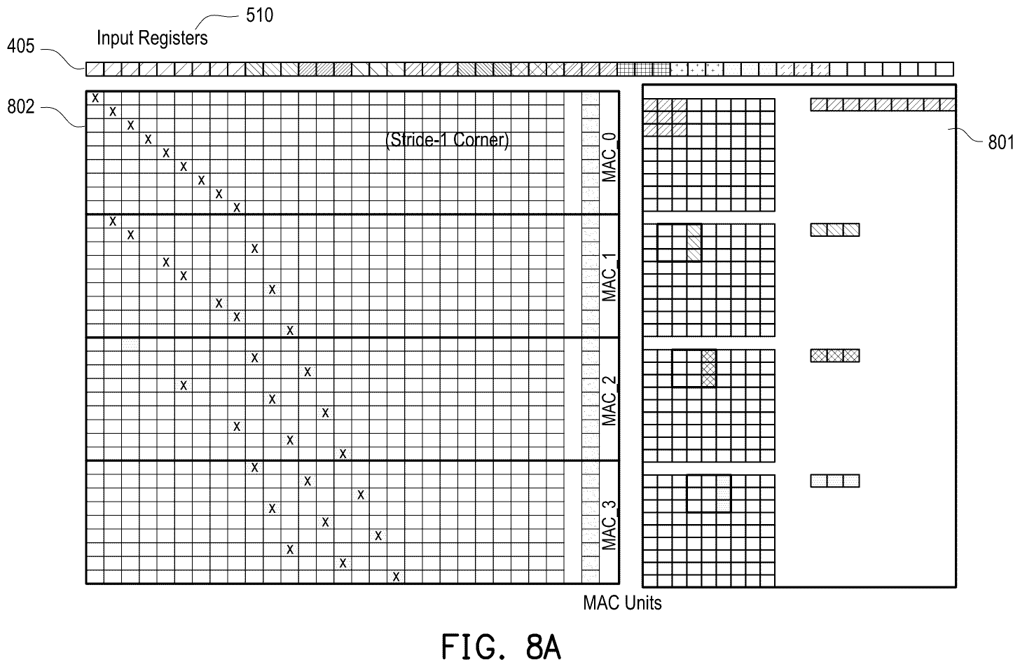

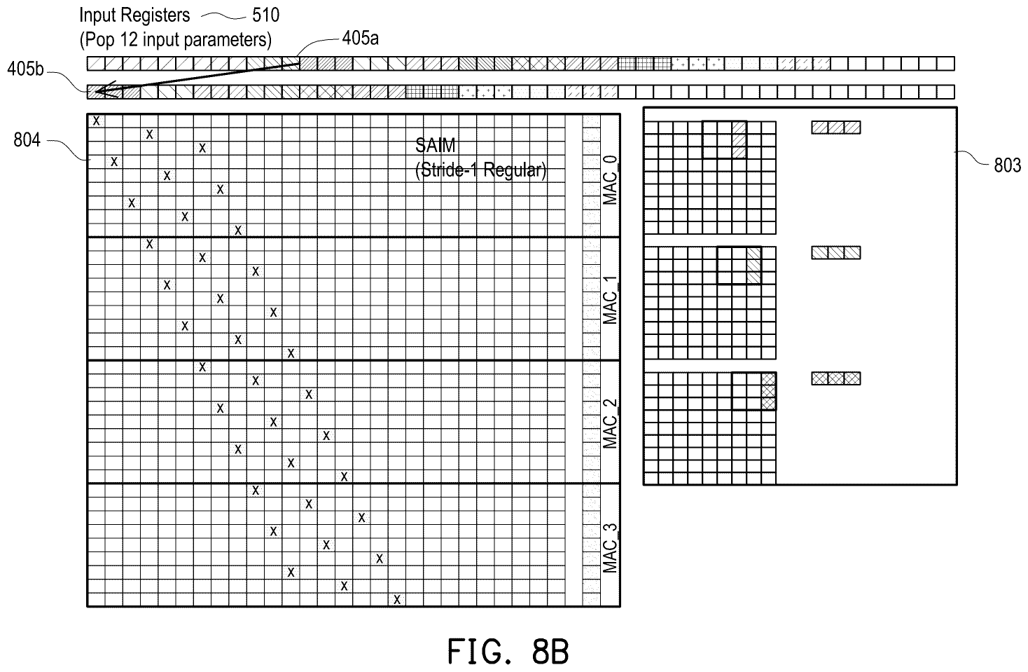

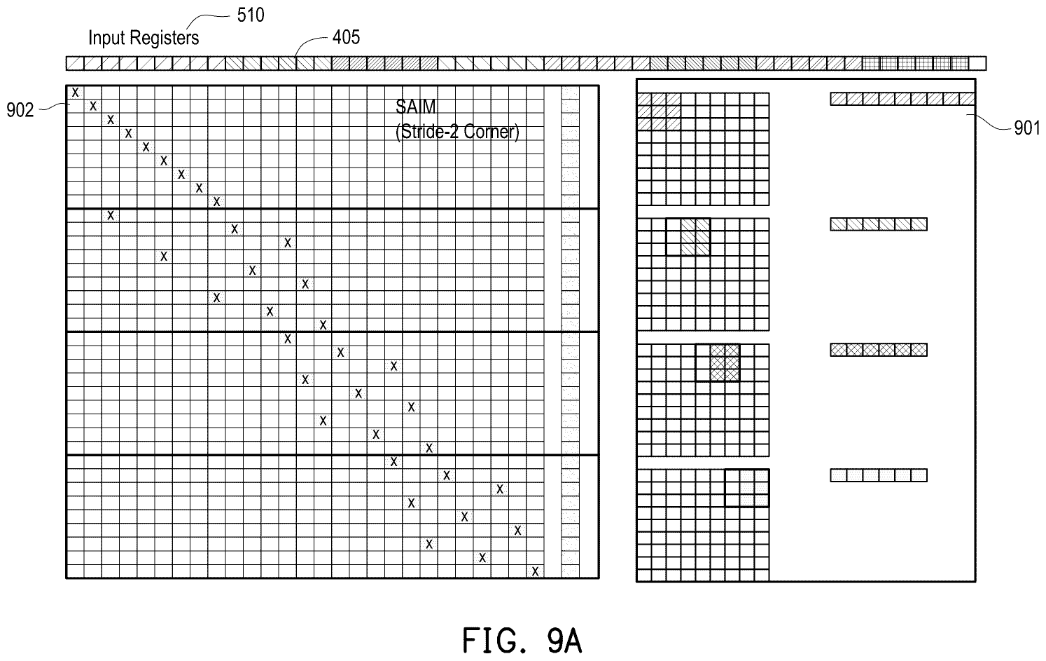

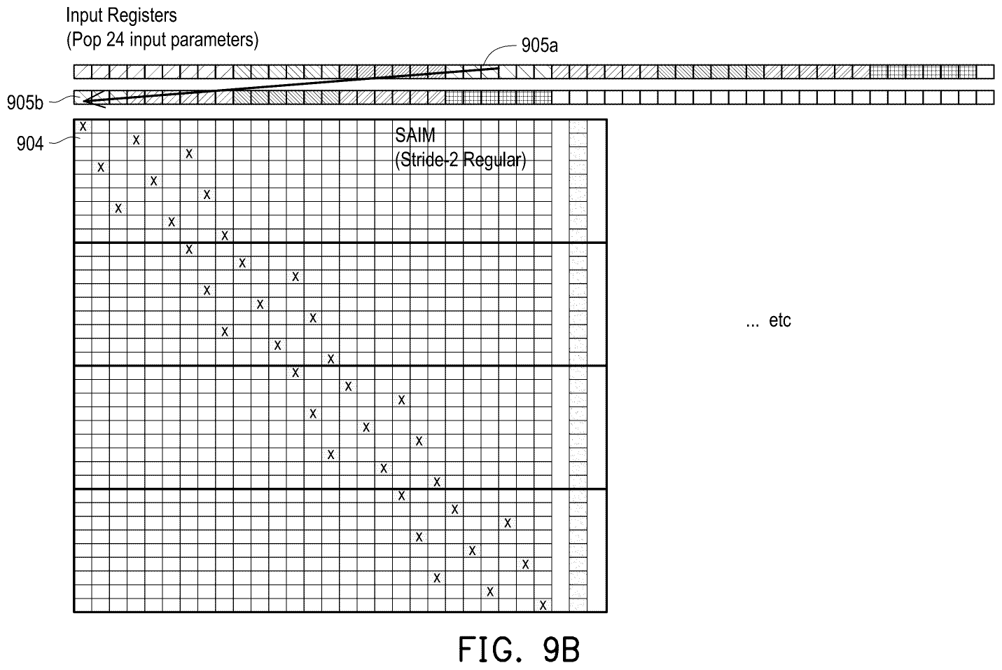

In one embodiment, input register 510 may load an input vector 405 (e.g., 432 bits) from an out-of-macro memory 402 shown in FIG. 4, and then selectively input at least a first part 514 of the input vector (e.g., 216 bits) to the stride matrix 520. Input register 510 may be controlled by a clock signal 511, a reset signal 512 and a mode signal 513. For example, mode signal 513 may control input register 510 to load a part 514 of the input vector is transmitted to stride matrix 520, e.g., the first 216 bits of the 432 bits of input vector 405, and then the second 216 bits of the 432 bits of input vector 405 may left shift and be loaded to the stride matrix 520. Additional details of the input register left shifting to “pop” input parameters out at each iteration may be illustrated in FIGS. 8A-8B and 9A-9B.

In one embodiment, stride matrix structure 520 may be implemented to map selected input parameters 514, e.g., a part from input vector 405 to their corresponding MAC units. Strode matrix structure 520 may perform the input mapping based on a stride mode signal 515. For example, stride mode signal 515 may contain 2 bits, e.g., taking a value from {00, 01, 10, 11}, to select which of four stride matrix maps, e.g., stride=1 and corner convolution, stride=1 and non-corner convolution, stride=2 and corner convolution, stride=2 and non-corner convolution.

In one embodiment, stride matrix has been designed to re-use data entries such that input 514 to output 408a-b may not be a 1-to-1 mapping. For example, in the example shown in FIG. 5, 216 input bits 514 may be mapped to 72×4=288 bits 408a-b.

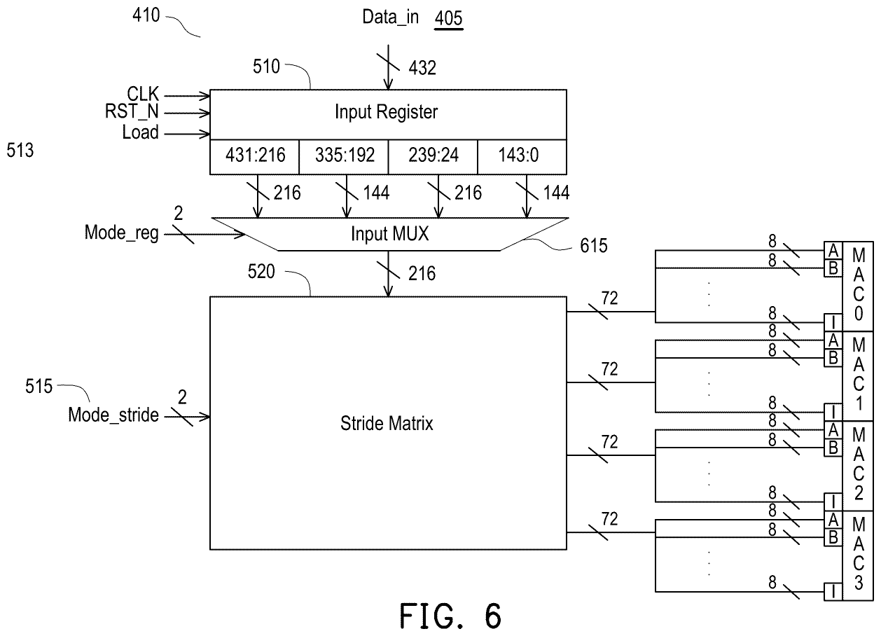

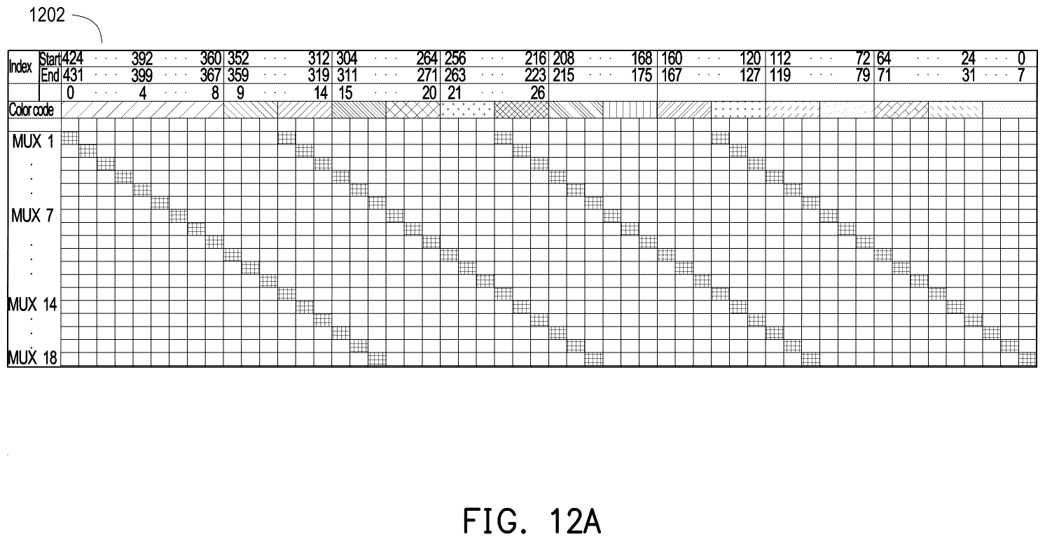

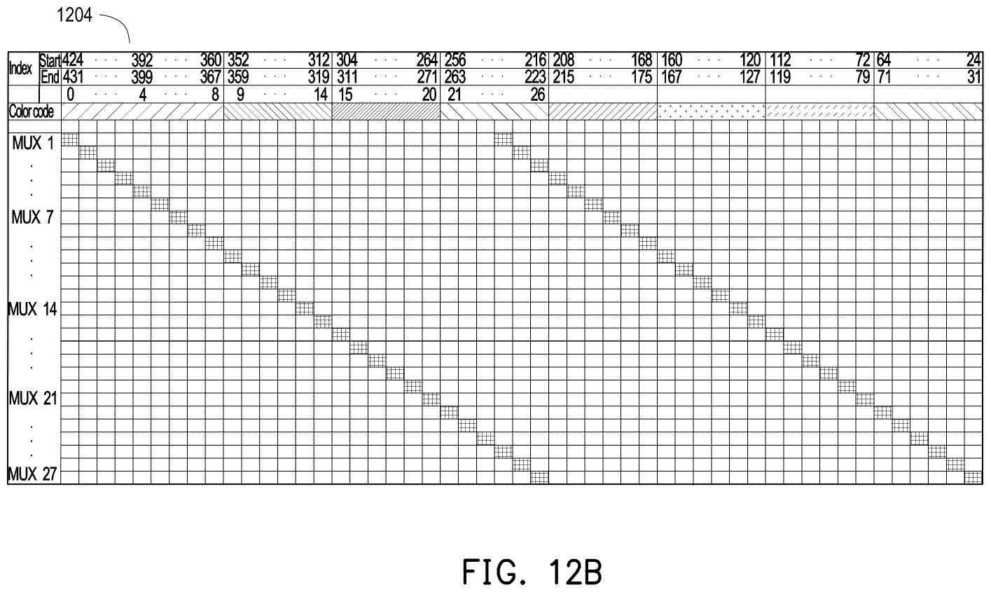

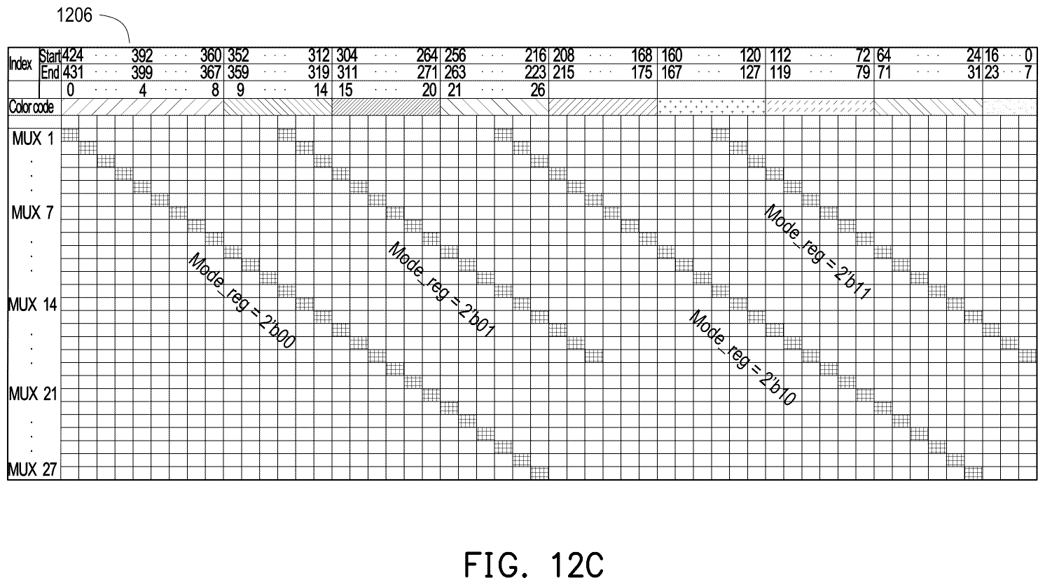

FIG. 6 shows an example structure of the stride-aware input mapping circuit 410 shown in FIG. 4 using an input multiplexer 615 to selectively input, according to one or more embodiments described herein. In one embodiment, an input multiplexer 615 is placed between the input register 510 and stride matrix 520 to selectively input a part of the input vector to the stride matrix according to control signal 513. For example, the input multiplexer 615 may be a 4-to-1 multiplexer that passes one of the input register groups, e.g., 216 bits [431:216], 144 bits [335:192], 216 bits [239:24], 144 bits [143:0] to stride matrix 520. Additional examples of input multiplexer 615 selecting the data entries to input to the stride matrix may be illustrated in relation to FIGS. 12A-12C.

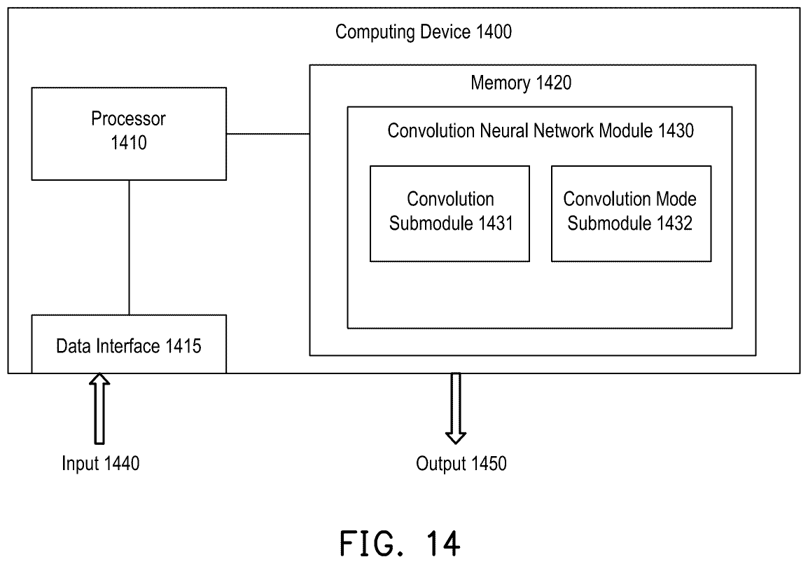

In one embodiment, control signal 513 may be a 2-bit signal, e.g., 00, 01, 10, 11, that selects which of the four input register groups is to be transmitted to stride matrix 520. For example, control signal 513 may be generated by a processor (e.g., processor 1410 in FIG. 14) depending on a status of current convolution mode.

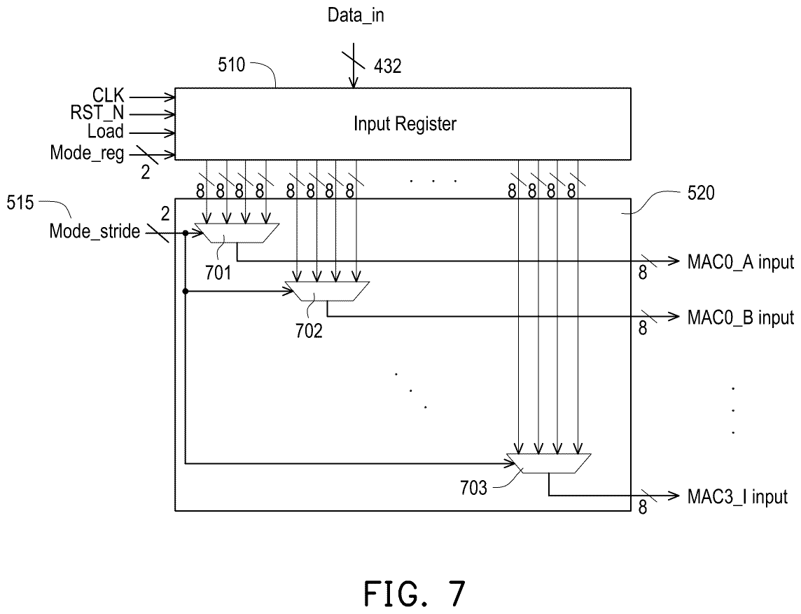

FIG. 7 shows an example circuit structure of the stride matrix 520 shown in FIGS. 5-6, according to one or more embodiments described herein. It is to be noted that FIG. 7 shown an example circuit structure of stride matrix 520 using a shift-type input register 510 shown in FIG. 5 for illustrative purpose only. An input multiplexer 615 may be added between input register 510 and stride matrix 520 as discussed in relation to FIG. 6.

In one embodiment, stride matrix 520 may comprise a plurality of multiplexers 701-703. For example, each multiplexer may be a 4-to-1 multiplexer that selects which input data should be pass through from register to a particular weight register at a particular MAC unit. The selection may be controlled by the mode stride control signal 515 indicating which one of the four convolution modes: stride=1 and corner convolution, stride=1 and non-corner convolution, stride=2 and corner convolution, stride=2 and non-corner convolution, is being implemented.

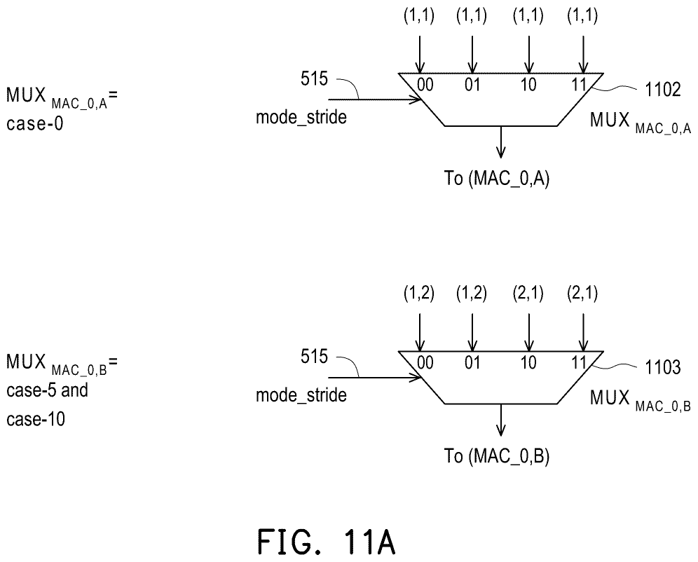

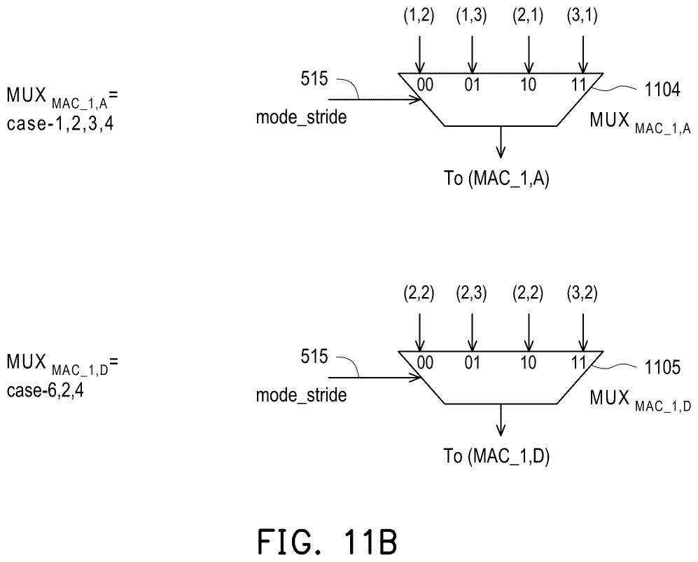

For example, for multiplexer 701, the selected output is connected to MACO_A input at a MAC unit. The connections between multiplexers 701-703 to different inputs at different MAC units may be designed based on a mapping matrix, as further described in FIGS. 11A-11B.

FIGS. 8A-8B illustrate example stride matrices for stride-1 convolution, according to one or more embodiments described herein. As shown in FIG. 8A, diagram 801 shows an example 9×9 input data array that is to be convolved with a 3×3 filter matrix. Non-repeated data entries as the convolution moves with stride=1 are unrolled from the 9×9 input data array to form the input vector 405, which is loaded at the input registers 510.

In one embodiment, the stride matrix 802 is shown for a stride-1 corner convolution at the first iteration. In the stride matrix 802, each “x” mark in the stride-1 corner matrix represents a connection from the input register to a MAC weight register to perform a multiplication of a data entry and a corresponding weight. For example, IN_REG [a,b] represents the data entry in the input register that corresponds to the data entry on the a-th row and b-th column in the input data array. The first row of stride matrix 802 connects the first data entry of the input register, IN_REG [1,1], to MAC register MAC_0 [A] to perform IN_REG [1,1]×MAC_0 [A]; IN_REG [1,2], to MAC register MAC_0 [B] and MAC register MAC_1 [A] to perform IN_REG [1,2]×MAC_0 [B] and IN_REG [1,2]×MAC_1 [A] and/or the like.

As shown in FIG. 8B, at the second iteration, 12 input parameters that have already been convolved in the first iteration may be “popped,” e.g., input vector may left shift such that position 405a may be shifted to the beginning of the vector. Diagram 803 shows non-repeated data entries that are unrolled from the 9×9 input data array for the second iteration. At the second iteration of a regular, non-corner convolution, stride matrix 804 may be used to map the input register to a MAC weight register to perform a multiplication of a data entry and a corresponding weight. For example, the first row of stride matrix 802 connects the first data entry of the input register, IN_REG [1,1] is mapped to MAC register MAC_0 [A] to perform IN_REG [1,1]×MAC_0 [A]; IN_REG [1,2], to MAC register MAC_0 [D] to perform IN_REG [1,2]×MAC_0 [D], and/or the like.

It is noted that FIGS. 8A-8B are for illustrative purpose only. To complete the convolution, input register 510 may continue to left shift and pop input parameters in one or more subsequent convolution iterations, and map the current input parameters to different MAC registers using the stride matrix 802 or 804 depending on the convolution mode.

FIGS. 9A-9B illustrate example stride matrices for stride-2 convolution, according to one or more embodiments described herein. As shown in diagram 901 of FIG. 9A, non-repeated data entries as the convolution moves with stride=2 are unrolled from the 9×9 input data array to form the input vector 405, which is loaded at the input registers 510.

In one embodiment, the stride matrix 902 is shown for a stride-2 corner convolution at the first iteration. In the stride matrix 902, each “x” mark in the stride-2 corner matrix represents a connection from the input register to a MAC weight register to perform a multiplication of a data entry and a corresponding weight. For example, the first row of stride matrix 902 connects the first data entry of the input register, IN_REG [1,1], to MAC register MAC_0 [A] to perform IN_REG [1,1]×MAC_0 [A]; IN_REG [1,2], to MAC register MAC_0 [B] to perform IN_REG [1,2]×MAC_0 [B], and/or the like. It is noted that the upper left corner of stride-1 corner matrix 802 may be similar to the upper left corner of stride-2 corner matrix 902.

As shown in FIG. 9B, at the second iteration, 24 input parameters that have already been convolved in the first iteration may be “popped,” e.g., input vector may left shift such that position 905a may be shifted to the beginning of the vector 905b. At the second iteration of a regular, non-corner convolution at stride=2, stride matrix 904 may be used to map the input register to a MAC weight register to perform a multiplication of a data entry and a corresponding weight. For example, the first row of stride matrix 802 connects the first data entry of the input register, IN_REG [1,1] is mapped to MAC register MAC_0 [A] to perform IN_REG [1,1]×MAC_0 [A]; IN_REG [1,2], to MAC register MAC_0 [D] to perform IN_REG [1,2]×MAC_0 [D], and/or the like.

It is noted that FIGS. 9A-9B are for illustrative purpose only. To complete the convolution, input register 510 may continue to left shift and pop input parameters in one or more subsequent convolution iterations, and map the current input parameters to different MAC registers using the stride matrix 902 or 904 depending on the convolution mode.

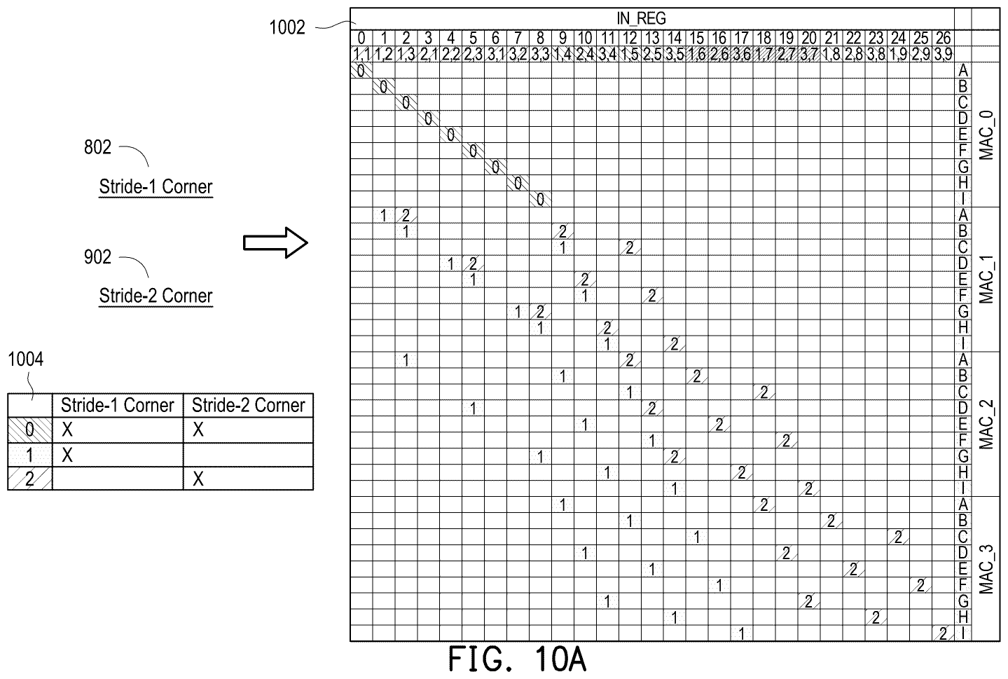

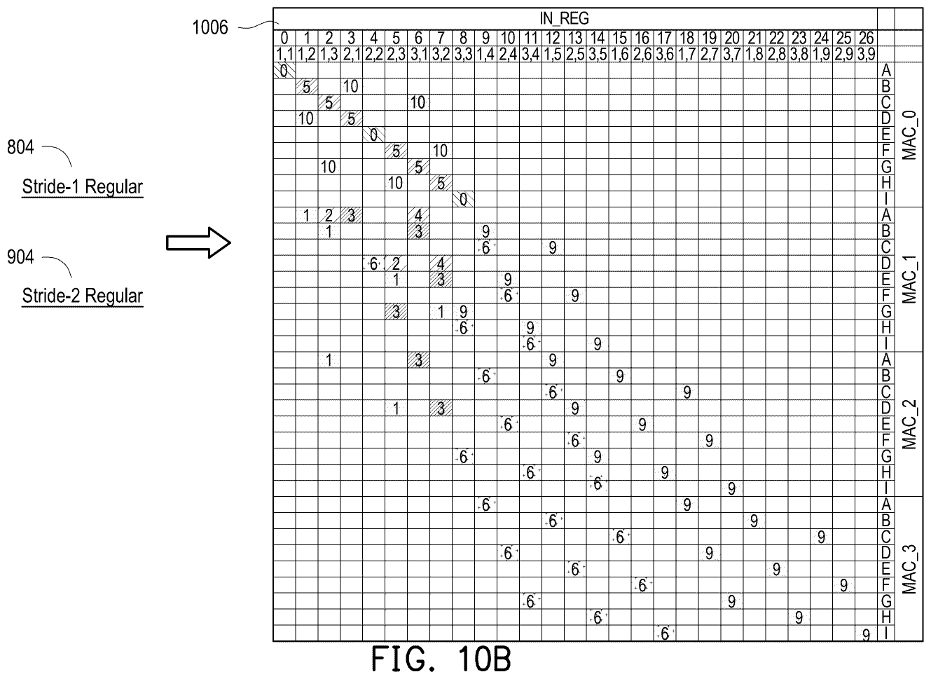

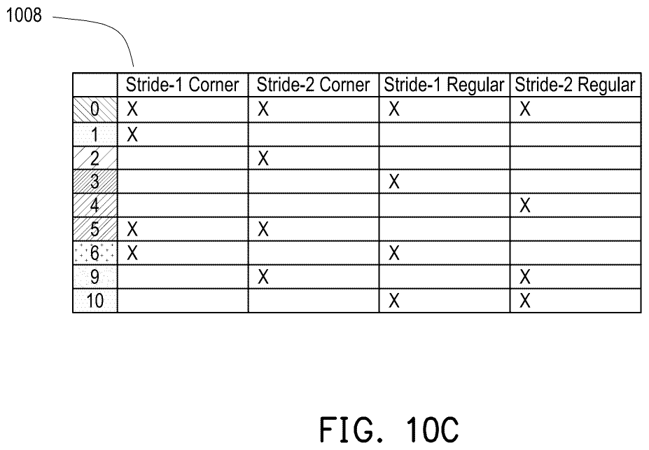

FIGS. 10A-10C illustrate example stride matrices for stride-1 and stride-2 combining the stride matrices design shown in FIGS. 8A-9B, according to one or more embodiments described herein. As shown in FIG. 10A, the stride-1 corner matrix 802 shown in FIG. 8A and the stride-2 corner matrix 902 shown in FIG. 9A may be superposed to form stride conner matrix 1002, which may be adopted to map input parameters from input registers according to a control signal indicating a stride mode (1 or 2).

For example, as shown in Table 1004, a “x” entry in stride matrix 1002 maps an input parameter to the corresponding MAC register for both stride-1 and stride-2 corner convolution. A “1” entry in stride matrix 1002 maps an input parameter to the corresponding MAC register only for stride-1 corner convolution. A “2” entry in stride matrix 1002 maps an input parameter to the corresponding MAC register only for stride-2 corner convolution.

As shown in FIG. 10B, the stride-1 regular (non-corner) matrix 804 shown in FIG. 8B and the stride-2 regular (non-corner) matrix 904 shown in FIG. 9B may be further superposed on top of stride matrix 1002 to form stride matrix 1006, which may be adopted to map input parameters from input registers according to a control signal indicating a stride mode (1 or 2) and a convolution mode (regular or corner).

For example, as shown in Table 1008 in FIG. 10C, the different number “0” to “10” in stride matrix 1006 indicates whether the respective entry is to apply to one or more of stride-1 corner convolution, stride-2 corner, stride-1 regular, or stride-2 regular convolution. For instance, when a control signal (e.g., 515 in FIGS. 5-6) indicate that the current iteration is for stride-1 corner convolution, based on the stride matrix 1006, IN_REG [1,1] is mapped to MAC_0[A] because in Table 1008, an entry “0” applies to any of the four modes of convolutions. For another instance, IN_REG [1,2] is mapped to MAC_0[B], because in Table 1008, an entry “5” applies to stride-1 corner or stride-2 corner, but an entry “10” does not apply to stride-1 corner —therefore, only the entry “5” connects IN_REG [1,2] to MAC_0[B] under stride-1 corner convolution.

FIGS. 11A-11B provide an illustrative example showing a hardware implementation of the superposed stride matrix 1006 in FIG. 10B, according to embodiments described herein. As illustrated in relation to FIG. 7, a stride matrix may be implemented by a number of multiplexers. In one embodiment, each row of stride matrix 1006 may be implemented by a multiplexer, e.g., a 4-to-1 multiplexer such as 1102 or 1103. A two-bit control signal (e.g., 515 in FIGS. 5-6) may take the values of “00”=stride-1 corner, “01”=stride-2 corner, “10”=stride-1 regular, and “11”=stride-2 regular.

For example, multiplexer 1102 represents the first row that maps data entries in the input registers to MAC_0[A]. In stride matrix 1006, IN_REG [1,1] is mapped to MAC_0[A] under any of the four modes of convolutions according to the entry “0” as defined in Table 1008. Therefore, the four inputs to multiplexers 1102 are all connected to IN_REG [1,1] such that the output of multiplexer 1102 is connected to MAC_0 [A] no matter what value the control signal 515 takes.

For another example, multiplexer 1103 represents the second row that maps data entries in the input registers to MAC_0[B]. In stride matrix 1006, IN_REG [1,2] under value “5” and IN_REG [2,1] under value “10” are mapped to MAC_0[B] in the second row. In Table 1008, an entry “5” applies to stride-1 corner and stride-2 corner, and an entry “10” applies to stride-1 regular and stride-2 regular. Therefore, IN_REG [1,2] is connected to the input for “00” (stride-1 corner) and “01” (stride-2 corner) of the multiplexer 1103, and IN_REG [2,1] is connected to the input for “10” (stride-1 regular) and “11” (stride-2 regular) of the multiplexer 1103. In this way, the output of multiplexer 1103 is connected to MAC_0[B] that chooses from one of the four inputs depending on the control signal 515.

For another example, multiplexer 1104 represents the 10th row that maps data entries in the input registers to MAC_1[A]. In stride matrix 1006, IN_REG [1,2] under value “1”, IN_REG [1,3] under value “2”, IN_REG [2,1] under value “3” and IN_REG [3,1] under value “4” are mapped to MAC_1[A] according to a respective convolution mode in the 10th row. In Table 1008, an entry “1” applies to stride-1 corner; an entry “2” applies to stride-2 corner; an entry “3” applies to stride-1 regular; and an entry “4” applies to stride-2 regular. Therefore, IN_REG [1,2] is connected to the input for “00” (stride-1 corner) of multiplexer 104; IN_REG [1,3] is connected to the input for “01” (stride-2 corner) of the multiplexer 1104; IN_REG [2,1] is connected to the input for “10” (stride-1 regular) of multiplexer 1104; and IN_REG [3,1] is connected to the input for “11” (stride-2 regular) of the multiplexer 1104. In this way, the output of multiplexer 1104 is connected to MAC_1[A] that chooses from one of the four inputs depending on the control signal 515.

For another example, multiplexer 1105 represents the 13th row that maps data entries in the input registers to MAC_1[D]. In stride matrix 1006, IN_REG [2,2] under value “6”, IN_REG [2,3] under value “2” and IN_REG [3,2] under value “4” are mapped to MAC_1[D] in the 13th row. In Table 1008, an entry “6” applies to stride-1 corner and stride-1 regular, and an entry “2” applies to stride-2 corner only, and an entry “4” applies to stride-2 regular only. Therefore, IN_REG [2,2] is connected to the input for “00” (stride-1 corner) and “10” (stride-1 regular) of the multiplexer 1105, and IN_REG [2,3] is connected to the input for “01” (stride-2 corner), and IN_REG [3,2] is connected to the input for “11” (stride-2 regular) of the multiplexer 1105. In this way, the output of multiplexer 1105 is connected to MAC_1[D] that chooses from one of the four inputs depending on the control signal 515.

As illustrated in FIGS. 10A-10B and 11A-11B, the stride matrix may be stored and/or implemented in various different embodiments. For example, in one implementation, different stride matrices may be stored separately for different strides and/or convolution mode (e.g., corner, or regular), e.g., a total of four different stride matrices, stride-1 corner 802, stride-1 regular 804, stride-2 corner 902 and stride-2 regular 904, may be stored and adopted separately. In another implementation, a superposed version 1002 of two matrices, e.g., stride-1 corner 802 and stride-2 corner matrices 902 may be superposed and implemented together. In another implementation, a superposed version 1006 of all four stride matrices may be stored and implemented together.

FIGS. 12A-12C illustrate example input multiplexer mapping using input multiplexer 615 in FIG. 6, according to one or more embodiments described herein. In one embodiment, instead of a shift-type input register that left shifts to pop input parameters after each convolution iteration, input multiplexer 615 may be used to select input parameters from the input register 510 to save dynamic power.

As shown in FIG. 12A, mapping matrix 1202 shows that the input multiplexer may select one of the groups of input data parameters 431:216, 335:192, 239:24 and 143:0 to output to the stride matrix 520, under stride-1 convolution.

As shown in FIG. 12B, mapping matrix 1204 shows that the input multiplexer may select one of the groups of input data parameters 431:216, and 239:24 to output to the stride matrix 520, under stride-2 convolution.

As shown in FIG. 12C, mapping matrix 1206 may combine mapping matrix 1202 and mapping matrix 1204 to map input data parameters, subject to a control signal (e.g., 513 in FIG. 6) indicating the stride and convolution mode. For example, when the control signal 513 indicates “00”=stride-1 corner, input parameters 431:216 are selected to output to the stride matrix; when the control signal 513 indicates “01”=stride-2 corner, input parameters 335:192 are selected to output to the stride matrix; when the control signal 513 indicates “10”=stride-1 regular, input parameters 239:24 are output to the stride matrix; and when control signal 513 indicates “11”=stride-2 regular, input parameters 143:0 are output to the stride matrix.

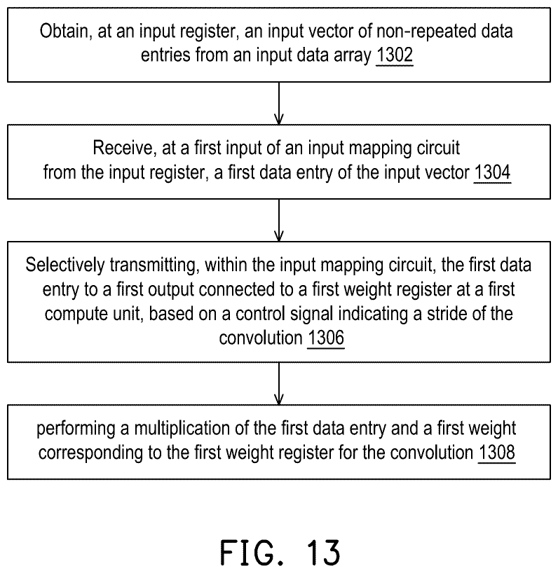

FIG. 13 is an example logic flow chart illustrating a process 1300 for performing a convolution of an input array with a filter matrix using circuit structures described in FIGS. 1-12, according to embodiments described herein. One or more of the processes of method 1300 may be implemented, at least in part, in the form of executable code stored on non-transitory, tangible, machine-readable media that when run by one or more processors may cause the one or more processors to perform one or more of the processes. In some embodiments, method 1300 corresponds to the operation of the convolution module 1431 that performs a convolution of an input data array with a filter matrix using one or more of the circuit structures discussed in FIGS. 4-6.

As illustrated, the method 1300 includes a number of enumerated steps, but aspects of the method 600 may include additional steps before, after, and in between the enumerated steps. In some aspects, one or more of the enumerated steps may be omitted or performed in a different order. Note that while operations are described as performing one convolution iteration, etc. the steps described herein may be performed iteratively for multiple convolution iterations and/or in parallel.

At step 1302, an input register (e.g., 510 in FIG. 5) may obtain an input vector (e.g., 405 in FIG. 5) of non-repeated data entries from an input data array (e.g., 402 in FIG. 4). For example, non-repeated data entries are unrolled from the input data array based on the stride of the convolution, as shown in FIG. 3B.

At step 1304, a first input of an input mapping circuit (e.g., stride matrix 520 in FIG. 5) may receive from the input register (e.g., 510 in FIG. 5), a first data entry (e.g., at least a data entry of the 216-bit input vector 514 in FIG. 5) of the input vector (e.g., the 432-bit input vector 405 in FIG. 5).

In one embodiment, the input register may be operated as a shift-type: output at least the first data entry of the input vector to the first output at a current iteration, and then left shift the input vector for a number of units, and output at least a second data entry of the shifted input vector to the input mapping circuit at a next iteration. The shift-type operation is described in relation to FIGS. 8A-9B.

In one embodiment, an input multiplexer (e.g., 615 in FIG. 6) may select a group of data entries from the input vector in the input register (e.g., 510 in FIG. 6) to output to the input mapping circuit at a current iteration. The input multiplexer selection is described in relation to FIGS. 12A-12C.

At step 1306, the input mapping circuit (e.g., stride matrix 520 in FIG. 5) may selectively transmit, within the input mapping circuit, the first data entry to a first output (e.g., any of 408a-d in FIG. 5) connected to a first weight register (e.g., any input of MAC units 421-424, such a MAC_0[A] in FIG. 5) at a first compute unit (e.g., MAC unit 421-424 in FIG. 5), based on a control signal (e.g., mode_stride signal 515 in FIG. 5) indicating a stride of the convolution.

For example, a matrix structure may be selected based on one or more control signals (e.g., 515 in FIG. 6) indicating the stride of the convolution, and a corner or non-corner mode of the convolution at a current iteration. The matrix structure (e.g., see stride matrices 802, 804, 902 and 904) is implemented by the input mapping circuit that selectively maps a set of inputs to a set of outputs.

In one embodiment, the matrix structure (e.g., stride matrix 1002 in FIG. 10A) may take a form of a superposition of a first matrix structure (e.g., stride matrix 802) corresponding to a first stride and a corner mode, and a second matrix structure corresponding to a second stride and a corner mode (e.g., stride matrix 902). The matrix structure (e.g., stride matrix 1006) may further take a form of a superposition of a first matrix structure corresponding to a first stride and a non-corner mode (e.g., stride matrix 804), and a second matrix structure corresponding to a second stride and a non-corner mode (e.g., stride matrix 904). The matrix structure is implemented by a plurality of multiplexers (e.g., 1102-1104 in FIGS. 11A-11B), and wherein each multiplexer corresponds to a row of the matrix structure.

At step 1308, a multiplication may be performed on the first data entry (e.g., IN_REG [1,1] in FIG. 10B) and a first weight corresponding to the first weight register (e.g., MAC_0 [A]) for the convolution.

Method 1300 may be performed iteratively for different iterations of convolution.

FIG. 14 is a simplified diagram illustrating a computing device implementing the convolution operation using an input mapping circuit described in FIG. 1-13, according to one embodiment described herein. As shown in FIG. 14A, computing device 1400 includes a processor 1410 coupled to memory 1420. Operation of computing device 1400 is controlled by processor 1410. And although computing device 1400 is shown with only one processor 1410, it is understood that processor 1410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 1400. Computing device 1400 may be implemented as a stand-alone subsystem, as a board added to a computing device, and/or as a virtual machine.

Memory 1420 may be used to store software executed by computing device 1400 and/or one or more data structures used during operation of computing device 1400. Memory 1420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 1410 and/or memory 1420 may be arranged in any suitable physical arrangement. In some embodiments, processor 1410 and/or memory 1420 may be implemented on a same board, in a same package (e.g., system-in-package), on a same chip (e.g., system-on-chip), and/or the like. In some embodiments, processor 1410 and/or memory 1420 may include distributed, virtualized, and/or containerized computing resources. Consistent with such embodiments, processor 1410 and/or memory 1420 may be located in one or more data centers and/or cloud computing facilities.

In some examples, memory 1420 may include non-transitory, tangible, machine readable media that includes executable code that when run by one or more processors (e.g., processor 1410) may cause the one or more processors to perform the methods described in further detail herein. For example, as shown, memory 1420 includes instructions for convolution neural network module 1430 that may be used to implement and/or emulate the systems and models, and/or to implement any of the methods described further herein. Convolution neural network module 1430 may receive input 1440 such as an input data array for convolution via the data interface 1415 and generate an output 1450 which may be the result of convolution.

The data interface 1415 may comprise a communication interface, a user interface (such as a voice input interface, a graphical user interface, and/or the like). For example, the computing device 1400 may receive the input 1440 (such as an input data array) from a networked database via a communication interface. Or the computing device 1400 may receive the input 1440, such as an input data array representing input question, from a user via the user interface.

In some embodiments, the convolution neural network module 1430 is configured to compute a convolution of an input data array with a filter matrix. The convolution neural network module 1430 may further include a convolution submodule 1431 and a convolution mode submodule 1432. The convolution mode submodule 1432 may determine a current convolution stride and a convolution mode and generate a control signal (e.g., 515 in FIG. 6) for the input mapping circuit (e.g., 510 in FIG. 6). The convolution submodule 1431 may perform the mapping and/or the multiplication of input data entries with weights in the weight registers in MAC units (e.g., 421-424 in FIG. 4).

Some examples of computing devices, such as computing device 1400 may include non-transitory, tangible, machine readable media that include executable code that when run by one or more processors (e.g., processor 1410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Computing device 1400 may comprise a circuit for a convolution of input data and a weight matrix. The circuit comprises an input register configured to store an input vector of non-repeated data entries from an input data array; an input mapping circuit configured to receive a first data entry from the input register, and selectively transmit the first data entry to a first output based on a control signal indicating a stride of the convolution. The first output is connected to a first weight register at a first compute unit that performs a multiplication of the first data entry and a first weight corresponding to the first weight register for the convolution.

Computing device 1400 may be comprised in a system for a convolution of input data and a weight matrix. The system comprises a memory storing a plurality of instructions, and one or more hardware processors executing the plurality of instructions to perform operations. The operations may comprise method 1300 shown in FIG. 13, such as: obtaining, at an input register, an input vector of non-repeated data entries from an input data array; receiving, at a first pin of an input mapping circuit from the input register, a first data entry of the input vector; selectively transmitting, within the input mapping circuit, the first data entry to a first output connected to a first weight register at a first compute unit, based on a control signal indicating a stride of the convolution; and performing a multiplication of the first data entry and a first weight corresponding to the first weight register for the convolution.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit for applying a convolution of input data and a filter, comprising:
an input mapping circuit including a plurality of multiplexers connected to implement a matrix structure that selectively maps an input vector, based on a control signal indicating a stride of the convolution, to a plurality of multiply-accumulate (MAC) units; and
the plurality of MAC units configured to perform a multiply-accumulate operation over a mapped vector from the input mapping circuit and a weight vector.

2. The circuit of claim 1, further comprising:
an input register configured to store and transmit the input vector to the input mapping circuit,
wherein the input vector is obtained by unrolling non-repeated data entries from an input data array based on the stride of the convolution.

3. The circuit of claim 2, wherein the input register is configured to transmit the input vector to the input mapping circuit by:
outputting at least a first data entry of the input vector at a current iteration; and
left shifting the input vector for a number of units; and
outputting at least a second data entry of the left-shifted input vector to the input mapping circuit at a next iteration.

4. The circuit of claim 1, further comprising:
an input multiplexer that selects a group of data entries from the input vector to output to the input mapping circuit at a current iteration.

5. The circuit of claim 1, wherein each of the plurality of multiplexer corresponds to a row of the matrix structure and the plurality of multiplexer collectively form the matrix structure based on the control signal indicating the stride of the convolution, and a corner or non-corner mode of the convolution at a current iteration.

6. The circuit of claim 5, wherein the matrix structure takes a form of a superposition of a first matrix structure corresponding to a first stride and a corner mode, and a second matrix structure corresponding to a second stride and a corner mode.

7. The circuit of claim 5, wherein the matrix structure takes a form of a superposition of a first matrix structure corresponding to a first stride and a non-corner mode, and a second matrix structure corresponding to a second stride and a non-corner mode.

8. The circuit of claim 1, further comprising:
a memory array storing a plurality of weight vectors representing rows or columns of the filter, wherein data entries of each weight vector are passed to weight registers of the plurality of MAC units at each iteration.

9. The circuit of claim 8, wherein each of the plurality of MAC unit performs a multiplication of a first data entry of the input vector and a first weight from a first weight register for the convolution.

10. The circuit of claim 1, wherein the circuit is a processing component of an artificial intelligence (AI) accelerator.

11. A method of applying a convolution of input data and a filter, comprising:
selectively mapping, by an input mapping circuit including a plurality of multiplexers connected that implements a matrix structure, an input vector, based on a control signal indicating a stride of the convolution, to a plurality of multiply-accumulate (MAC) units; and
performing, by the plurality of MAC units, a multiply-accumulate operation over a mapped vector from the input mapping circuit and a weight vector.

12. The method of claim 11, further comprising:
transmitting, from an input register, the input vector to the input mapping circuit,
wherein the input vector is obtained by unrolling non-repeated data entries from an input data array based on the stride of the convolution.

13. The method of claim 12, further comprising:
outputting, by the input register, at least a first data entry of the input vector at a current iteration; and
left shifting the input vector for a number of units; and
outputting by the input register, at least a second data entry of the left-shifted input vector to the input mapping method at a next iteration.

14. The method of claim 11, further comprising:
selecting, by an input multiplexer, a group of data entries from the input vector to output to the input mapping method at a current iteration.

15. The method of claim 11, wherein each of the plurality of multiplexer corresponds to a row of the matrix structure and the plurality of multiplexer collectively form the matrix structure based on the control signal indicating the stride of the convolution, and a corner or non-corner mode of the convolution at a current iteration.

16. The method of claim 15, wherein the matrix structure takes a form of a superposition of a first matrix structure corresponding to a first stride and a corner mode, and a second matrix structure corresponding to a second stride and a corner mode.

17. The method of claim 15, wherein the matrix structure takes a form of a superposition of a first matrix structure corresponding to a first stride and a non-corner mode, and a second matrix structure corresponding to a second stride and a non-corner mode.

18. The method of claim 11, further comprising:
storing, at a memory array, a plurality of weight vectors representing rows or columns of the filter, wherein data entries of each weight vector are passed to weight registers of the plurality of MAC units at each iteration.

19. The method of claim 18, further comprising:
performing, by each of the plurality of MAC unit, a multiplication of a first data entry of the input vector and a first weight from a first weight register for the convolution.

20. An artificial intelligence (AI) accelerator comprising one or more convolution circuits to perform a convolution of input data and a filter, each convolution circuit comprising:
an input mapping circuit including a plurality of multiplexers connected to implement a matrix structure that selectively maps an input vector, based on a control signal indicating a stride of the convolution, to a plurality of multiply-accumulate (MAC) units; and
the plurality of MAC units configured to perform a multiply-accumulate operation over a mapped vector from the input mapping circuit and a weight vector.
